(19) United States
(12) Patent Application Publication
(10) Pub. No.: US 2011/0288893 A1
(43) Pub. Date: Nov. 24, 2011

(54) Virtual Travel, Restaurant and Entertainment Booking Magazine

(76) Inventor: Mitchell J. Francis, Beverly Hills, CA (US)

(21) Appl. No.: 13/111,698

(22) Filed: May 19, 2011

Related U.S. Application Data
(60) Provisional application No. 61/347,080, filed on May 21, 2010.

(51) Int. Cl. G06Q 30/00; G06Q 10/00

(52) U.S. Cl. 705/5

(57) ABSTRACT

A reservation, sales, ordering and information system is disclosed. The system includes a front end interface network including a graphical user interface virtual travel, restaurant and entertainment booking magazine operating on multiple consumer computers and a back end network composed of a network of data sources, data input mechanisms and processing mechanisms available via the graphical user interface. The graphical user interface is composed of a virtual travel, restaurant and entertainment booking magazine replicating a travel magazine providing ready access to information.

### CROSS REFERENCE TO RELATED APPLICATIONS

This application claims the benefit of U.S. Provisional Patent Application Ser. No. 61/347,080, entitled “VIRTUAL TRAVEL, RESTAURANT AND ENTERTAINMENT BOOKING MAGAZINE”, filed May 21, 2010.

### BACKGROUND OF THE INVENTION

1. Field of the Invention

The invention relates to a travel, restaurant and entertainment reservation, sales, ordering and information system employing a virtual travel, restaurant and entertainment booking magazine.

2. Description of the Related Art

Traditional print travel magazines offer consumers vast amounts of information regarding their travel destinations. These magazines provide interesting articles concerning hotels, restaurants and other attractions, as well as coupons and advice consumers may use.

However, print magazines are limited. They must be prepared in advance. The available content is confined by the desired page count. Printing and distribution costs must be balanced with the ultimate return. Updates are difficult and expensive. Consumers are required to access other resources for information not included in the print magazine.

Although print travel magazines are still highly popular, they have been supplemented by travel web sites. These web sites allow consumers to access vast amounts of information, which may be readily and regularly updated without the print and distribution costs associated with a traditional print magazine.

However, travel web sites are also limited in that they require consumers to “jump” from web page to web page, often losing track of the starting point for their research. In addition, these travel webs sites are visually very different from the tried and true print magazine format that many consumers have become accustomed to and enjoy.

The present invention overcomes these shortcomings by providing a travel, restaurant and entertainment reservation, sales, ordering and information system employing a virtual travel, restaurant and entertainment booking magazine allowing consumers to replicate the well-known experience of “thumbing through” a travel magazine with the online experience of readily accessing information through hypertext and other linking techniques.

### SUMMARY OF THE INVENTION

It is, therefore, an object of the present invention to provide a reservation, sales, ordering and information system including a front end interface network composed of a graphical user interface operating on multiple consumer computers and a back end network composed of a network of data sources, data input mechanisms and processing mechanisms available via the graphical user interface. The graphical user interface is composed of a virtual travel, restaurant and entertainment booking magazine replicating a travel magazine providing ready access to information.

It is also an object of the present invention to provide a system wherein the virtual travel, restaurant and entertainment booking magazine provides access to reviews and video promotional materials regarding travel, restaurant or entertainment information of interest.

It is another object of the present invention to provide a system wherein the virtual travel, restaurant and entertainment booking magazine provides ordering, reserving, or purchasing of services or goods.

It is a further object of the present invention to provide a system wherein the back end network includes a content server linked to a plurality of providers of goods or services via a global communication network.

It is also an object of the present invention to provide a system wherein the content server stores and distributes content relating to goods or services of the plurality of providers for viewing upon the graphical user interface.

It is another object of the present invention to provide a system wherein the content server includes a booking engine allowing for transactions relating to ordering, reserving or otherwise purchasing of goods or services of the plurality of providers.

It is a further object of the present invention to provide a system wherein each of the plurality of providers is enabled to access the content server for updating travel, restaurant or entertainment content stored upon the content server.

It is also an object of the present invention to provide a system wherein each of the plurality of providers directly connects with the content server for the purpose of updating information or inventory.

It is another object of the present invention to provide a system wherein each of the plurality of providers forwards information or inventory to a consolidator that is directly connected with the content server.

It is a further object of the present invention to provide a system wherein each of the plurality of providers forwards information or inventory to an operator of the content server who will then update the information or inventory on the content server.

It is also an object of the present invention to provide a system wherein the graphical user interface provides links to articles, hotels, shows, restaurants, attractions and hot deals.

It is another object of the present invention to provide a system wherein for each of the links to articles, hotels, shows, restaurants, attractions and hot deals the graphical user interface provides a link offering an option of watching a video promo, booking a reservation or viewing rates and reviews.

It is a further object of the present invention to provide a system wherein the links offering the consumer the option of watching a video promo, booking a reservation or viewing rates and reviews direct the consumer to a window displaying the content.

It is also an object of the present invention to provide a system wherein the virtual travel, restaurant and entertainment booking magazine includes a cover, a table of contents with hypertext links to the various sections of the virtual travel, restaurant and entertainment booking magazine, and descriptive material shown in an open magazine format.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the present travel, restaurant and entertainment reservation, sales, ordering and information system.

FIGS. 2-8 are representative pages from the present virtual travel, restaurant and entertainment booking magazine.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

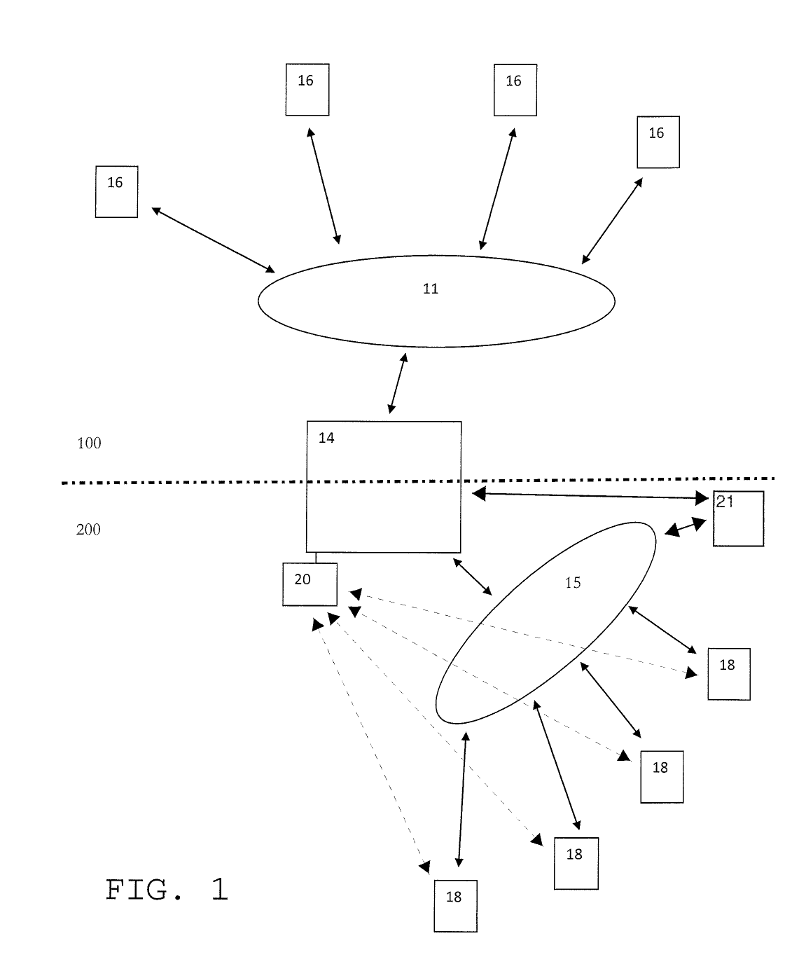

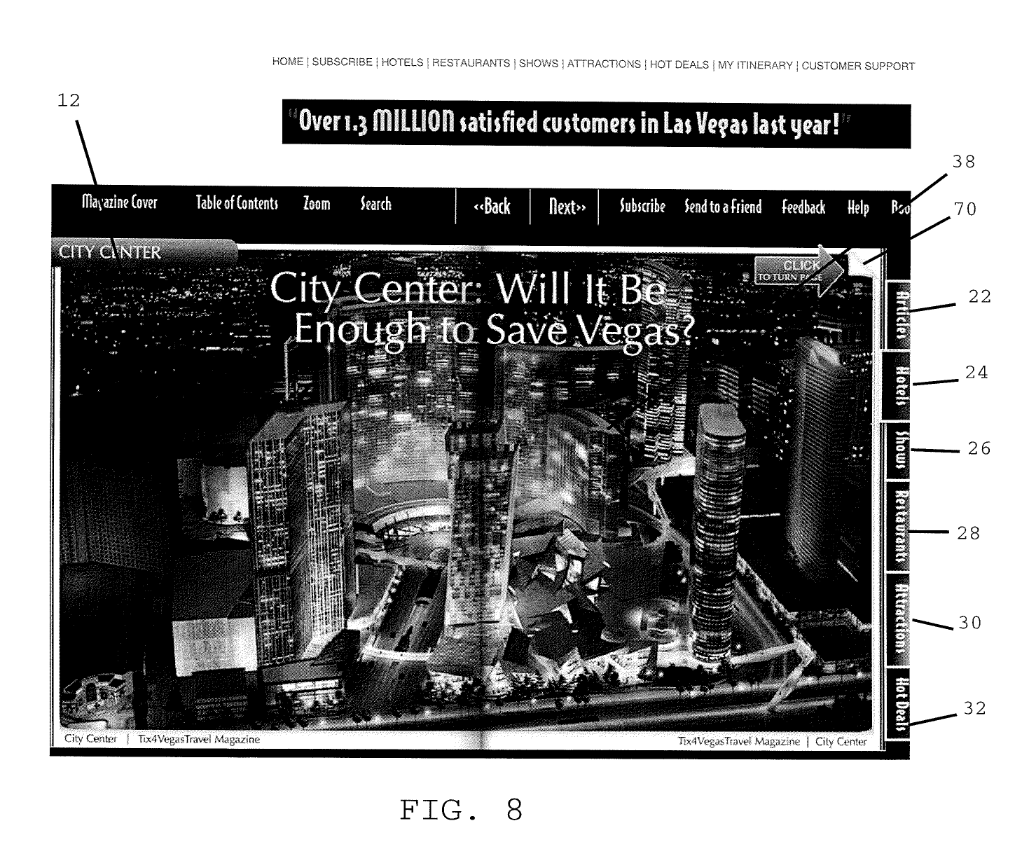

In accordance with the present invention, and with reference to FIGS. 1 to 8, a travel, restaurant and entertainment reservation, sales, ordering and information system 10 is disclosed. The system 10 employs a virtual travel, restaurant and entertainment booking magazine 12 allowing consumers to replicate the well-known experience of “thumbing through” a travel magazine with the online experience of readily accessing information through hypertext and other linking techniques. The present system 10 further allows consumers to combine the tried and true experience of travel, restaurant and entertainment magazines with the online convenience of immediate access to a wide variety of reviews and video promotional materials regarding travel, restaurant and entertainment information of interest. The present system 10 further provides the online convenience of ordering, reserving, and/or otherwise purchasing services and goods (that is, booking goods and/or services) from the comfort of one's own home. Still further, the present system 10 allows the providers of travel, restaurant and entertainment services and/or goods to integrate advertisements with the other information provided via the present virtual travel, restaurant and entertainment booking magazine 12.

While the term “magazine” is used herein to describe the format of the interface for the present system, it could be thought of as a guide or other information source commonly employed in a paper format. In addition, it should be appreciated the term “travel” is intended to cover a variety of travel related topics including, but not limited to, hotels, car rentals, airfare, etc.

The system 10 includes a content server 14 linked to a plurality of consumer computers 16 upon which consumers view the virtual travel, restaurant and entertainment booking magazine via a global communication network (for example, the Internet) 15. The content server 14 stores and distributes travel, restaurant and/or entertainment content relating to information of interest and inventory relating to the goods and/or services being offered for viewing as a graphical user interface upon consumer computers 16. The content server 14 also functions as a booking engine allowing for transactions relating to ordering, reserving and/or otherwise purchasing goods and/or services in accordance with the present invention. Each of the plurality of providers 18 within the travel, restaurant and entertainment industry is linked to the content server 14. Each of the plurality of providers 18 is enabled to access the content server 14 for updating travel, restaurant and/or entertainment content stored upon the content server 14. In accordance with a preferred embodiment, and in a further effort to appreciate the concepts underlying the present invention, the term “providers” is meant to refer to those people and other entities intimately responsible for supplying inventory relating to travel, restaurant and/or entertainment events, services and/or goods.

The providers 18 are either directly or indirectly linked to the content server 14. That is, (1) the providers 18 may directly connect with the content server 14 (for example, via the Internet 15) for the purpose of updating information and/or inventory, (2) the providers 18 may forward information and/or inventory to a consolidator 21 that is directly connected with the content server 14, or (3) the providers 18 may simply forward information and/or inventory to the operator 20 of the content server 14 who will then update the information and/or inventory on the content server 14. As those skilled in the art will certainly appreciate, a consolidator (and/or affiliate) is an individual or company, which gathers inventory and/or information from one or many providers for dissemination via the Internet. In accordance with the present invention, a consolidator (and/or affiliate) is one who gathers inventory and/or information from one or many providers for incorporation within the present magazine (and related booking engine associated therewith). In accordance with a preferred embodiment, it is contemplated the indirect method of updating is preferred although it is certainly within the scope of the present invention to provide for direct content updating.

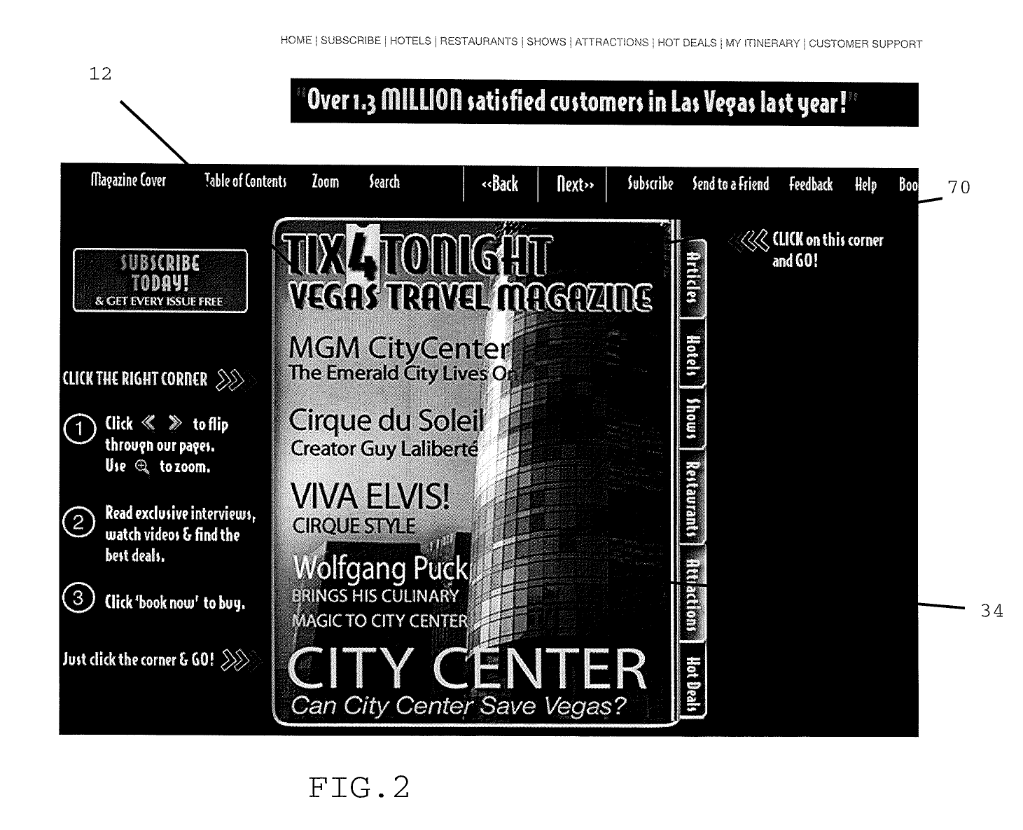

Referring to FIGS. 2-8, the graphical user interface of the present system 10 is in the form of a virtual travel, restaurant and entertainment booking magazine 12 operating on multiple consumer computers 16 upon which the consumer views the travel, restaurant and entertainment content offered by the content server 14 includes links to travel, entertainment, and restaurant information and/or inventory, for example, links to Articles 22, Hotels 24, Shows 26, Restaurants 28, Attractions 30 and Hot Deals 32. It is further contemplated the virtual travel, restaurant and entertainment booking magazine 12 may include links to other travel related topics, for example, destination resorts, airfare, car rentals, etc. For each type of content of interest to a consumer, and as discussed below in detail with reference to the shows and hotels content, the graphical user interface provides a link offering the consumer the option of watching a video promo, booking a reservation (or otherwise purchasing or ordering the item of interest) or viewing rates and reviews.

The information and/or inventory relating to travel, entertainment and restaurant are incorporated into the present system 10 through a variety of mechanisms known to those skilled in the art. For example, (1) the travel, entertainment and restaurant inventory and/or information may be directly stored on the content server 14 of the present system 10, (2) the travel, entertainment and restaurant inventory and/or information may be stored at the servers of the travel, entertainment and restaurant providers 18 with direct links to the content server 14, (3) the travel, entertainment and the restaurant inventory and/or information may be stored at a server of a consolidator(s) 21 with direct links to the content server 14, or (4) via other data storage mechanisms known to those skilled in the art. As such, the present system 10 provides a front end interface network 100, that is, a graphical user interface composed of the virtual magazine 12 operating on multiple consumer computers 16 and associated supporting network infrastructure including the content server 14, global communication network 11, and consumer computers 16, and a back end network 200 of data sources, data input mechanisms and processing mechanisms available via the virtual magazine 12 including the content server 14, operator 20, global communication network 15, and providers 18.

For each type of content, and as discussed below with reference to the shows and hotels information and/or inventory, the graphical user interface provides a link offering the consumer the option of watching a video, booking a reservation (or otherwise purchasing or ordering the item of interest) or viewing rates and reviews.

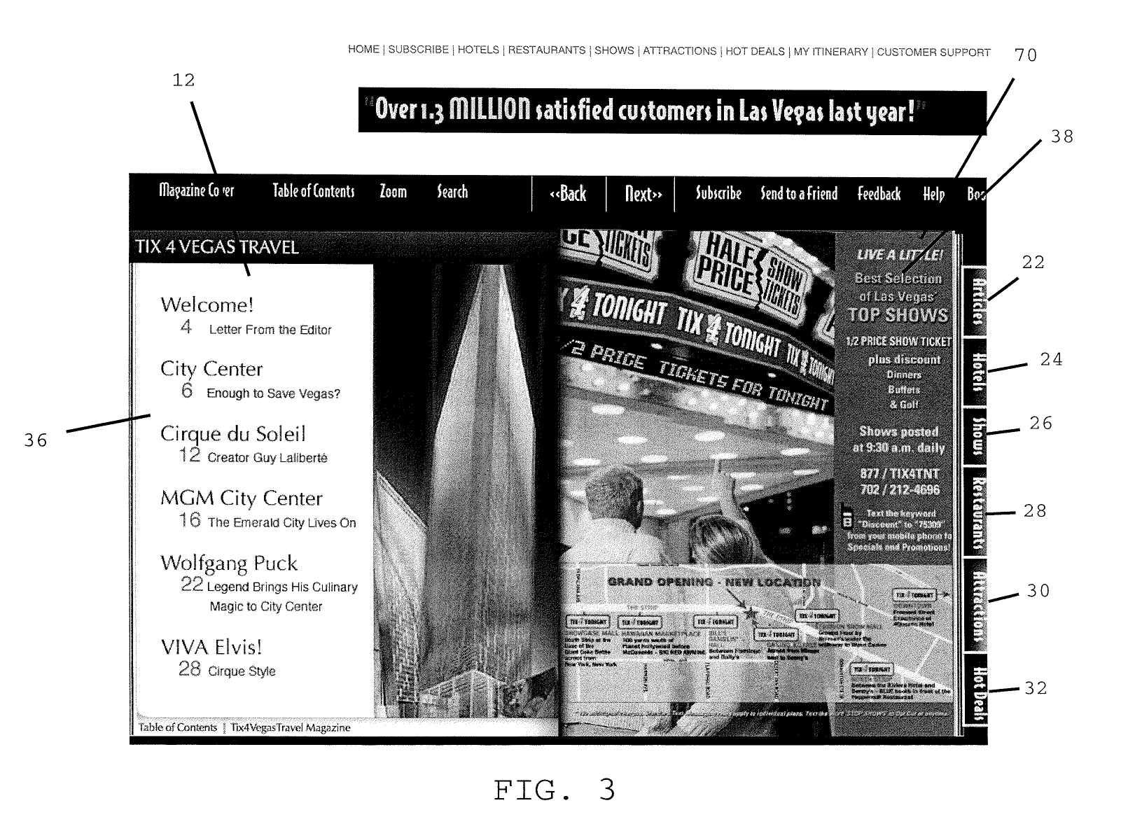

With this in mind, the graphical user interface appears on the consumer computers 16 as a virtual travel, restaurant and entertainment booking magazine 12 with a cover 34 (see FIG. 2), a table of contents 36 (see FIG. 3) with hypertext links to the various sections of the virtual magazine 12, and descriptive material 38 (see FIGS. 3-8) shown in an open magazine format with pages that turn in much the same manner a traditional magazine is turned from page to page. In accordance with a preferred embodiment, the reader will see the pages flip with accompanying sound effects. Although a table of contents 36 is one navigational tool contemplated for use in accordance with the present invention, other navigational mechanisms may be employed within the spirit of the present invention. For example, tabs and sub tabs might be used in navigating within the present virtual magazine. For example, the consumer may turn the pages of the virtual travel, restaurant and entertainment booking magazine 12 by simply clicking on an icon 44 indicating page-by-page browsing of the virtual travel, restaurant and entertainment booking magazine 12 or clicking on a page icon (or index tabs) designated in the table of contents 36 for immediate access to a specific article in the virtual travel, restaurant and entertainment booking magazine 12.

Page turning, and general handling of the virtual travel, restaurant and entertainment booking magazine is accompanied by the visual and audible characteristics associated with reading a magazine. In particular, pages are turned by clicking upon a corner of the virtual magazine 12 and the common sound of rustling paper is generated in conjunction with the turning pages of the virtual magazine.

With this in mind, and considering the fact that the providers 18 may be allowed access to the content server 14 (in accordance with one embodiment of the present invention) for updating of information and/or inventory provided thereon, each of the providers 18 is provided with interface software compatible with the content server 14 for facilitating the uploading of relevant travel information and/or inventory to the content server 14. As such, the interface software provides an interface through which each of the plurality of providers 18 selectively enters available information and/or inventory that is subsequently uploaded to the content server 14 for access by patrons. In addition to the provider uploading information and/or inventory, the “publisher” of the present virtual magazine may upload the information and/or inventory for display in the present virtual magazine.

As discussed above, the graphical user interface 12 of the present system 10 is designed to replicate the look and feel of a traditional magazine. However, and in contrast to a traditional magazine, the present graphical user interface 12 allows a consumer to move from information/inventory to information/inventory by simply clicking upon various icons found throughout the pages of the virtual travel, restaurant and entertainment booking magazine. The present virtual travel, restaurant and entertainment booking magazine 12 allows the consumer to order, reserve and/or otherwise purchase goods and/or services. The present virtual travel, restaurant and entertainment booking magazine 12 also allows consumers to see video promos, read reviews and advertisements in order to fully inform themselves before making their orders, reservations or purchases. As a result, it should be appreciated the following discussion of the graphical user interface takes place in the confines of a virtual magazine.

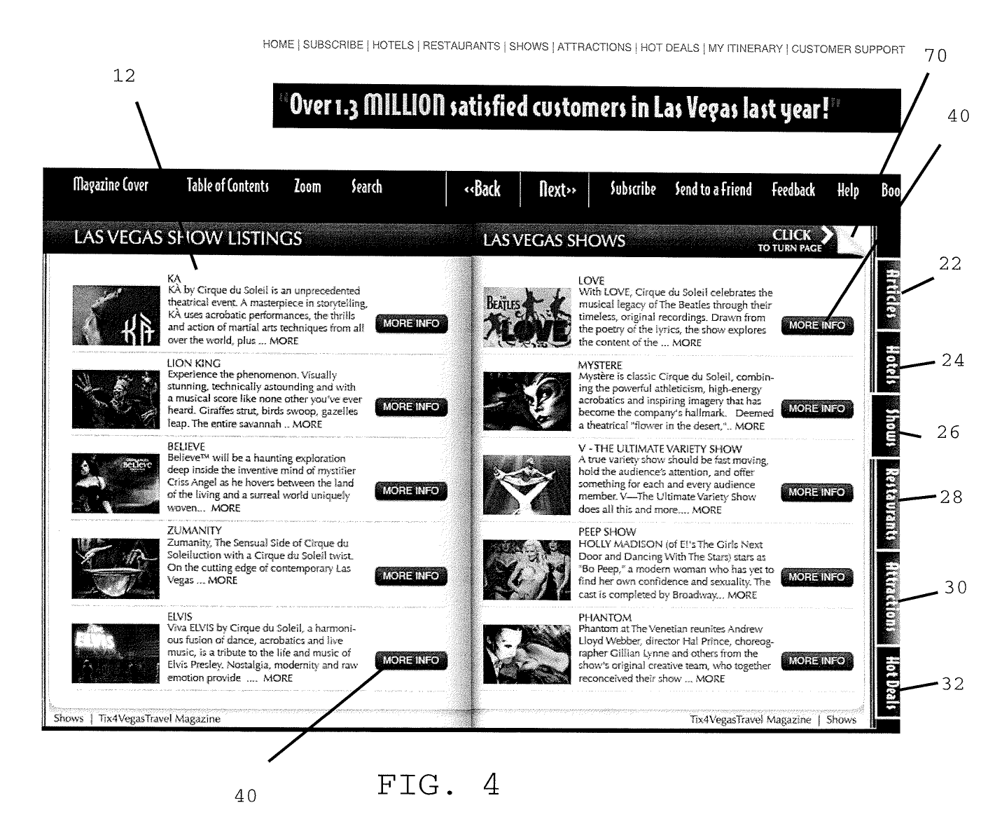

As discussed above, a graphical user interface in the form of a virtual travel, restaurant and entertainment booking magazine 12 provides consumers of the present system with links to travel, restaurant and/or entertainment information and/or inventory content selected from the group of Articles 22, Hotels 24, Shows 26, Restaurants 28, Attractions 30 and Hot Deals 32. With this in mind, the virtual magazine 12 is respectively provided with links in the form of indexed tabs 22, 24, 26, 28, 30, 32 allowing consumers with ready access to a variety of travel, restaurant and entertainment information and/or inventory content. It is further contemplated the links may be provided in the form of traditional pull down menus or other graphic interface mechanisms known to those skilled in the art. For example, and when a consumer wishes to explore potential shows and the travel information relating thereto, the cursor is positioned over the shows link (or tab) 26 and clicked (see FIG. 2). Once the Shows tab 26 is clicked, the consumer is brought to the shows section (see FIG. 4) and is provided with a listing of shows (including summaries of each show).

Once desired content is identified by the consumer, the consumer is provided with various options in relation to that content. The additional content, for example with reference to the shows, is accessed by clicking the MORE INFO button 40 (or other named buttons as may occur) adjacent to the show of interest.

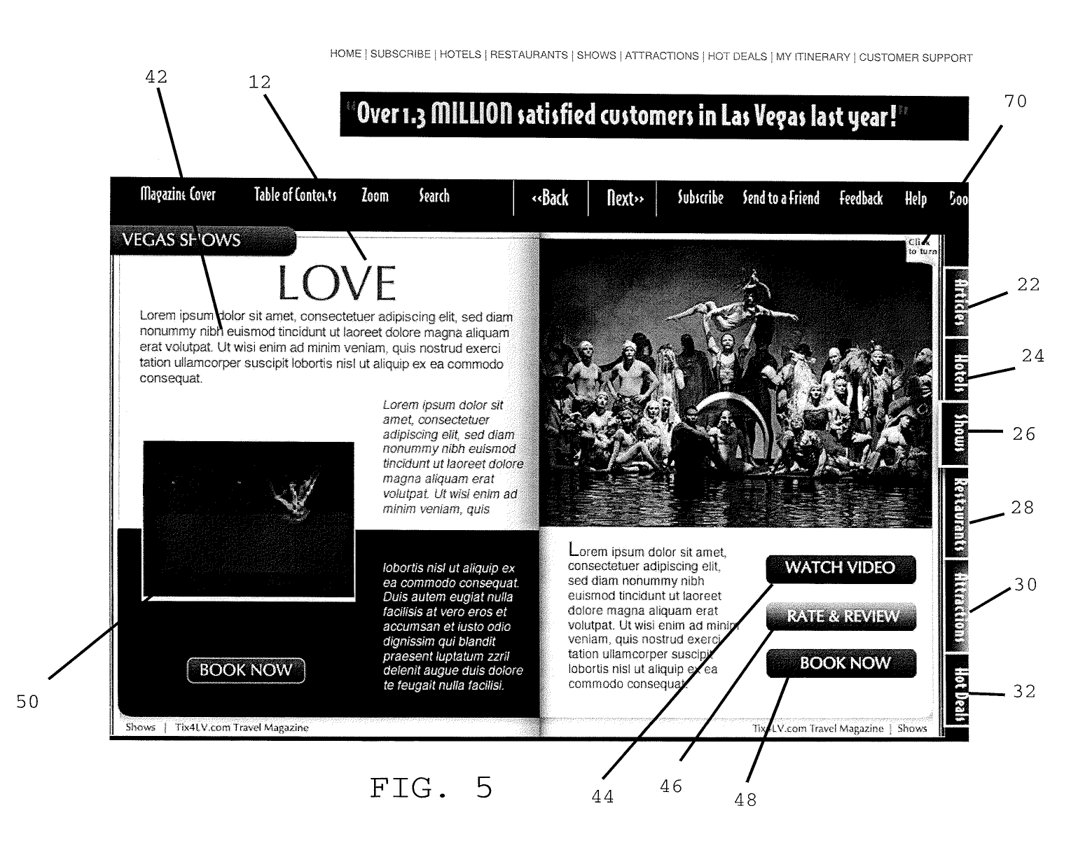

More particularly, and with reference to shows page shown in FIG. 4, after the MORE INFO button 40 relating to the show LOVE is clicked the consumer is provided with detailed information regarding the show LOVE (see FIG. 5). In addition to written information 42, the user is provided the opportunity to watch a promotional video of the show 44, book a reservation 46, and/or view rates and reviews 48. When these tabs are clicked and the information and/or inventory is retrieved for viewing by the consumer, the information and/or inventory is provided in the form of windows displayed within the context of, or otherwise in conjunction with, the virtual, travel, restaurant and entertainment booking magazine 12. As such, when a consumer wishes to watch a show, a video window 50 will open within the virtual magazine (or it might open in a separate window) providing a brief promotional video for the show. Similarly, when the consumer wishes to purchase tickets for the show, a purchase window will open through which the user may purchase tickets for the show. Still further, when the consumer wishes to view rates and reviews, a window is opened providing the information desired by the consumer. Similar windows are opened depending upon the links selected and the travel information being reviewed by the consumer.

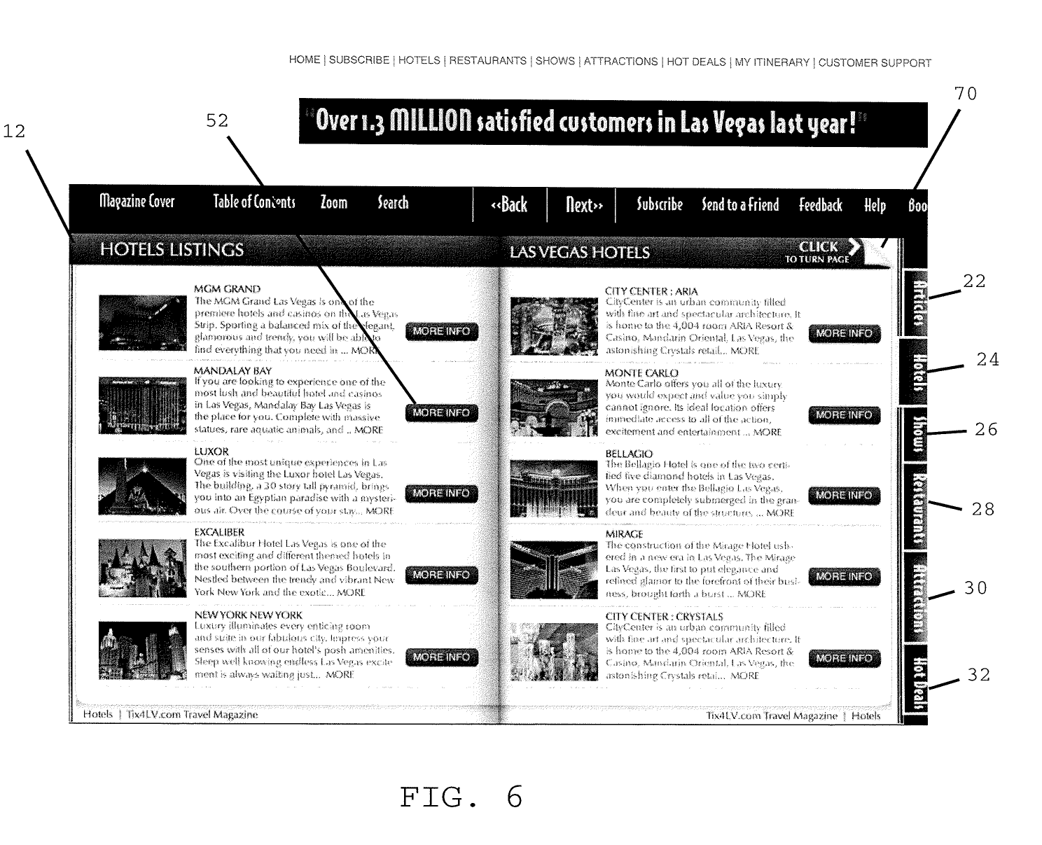

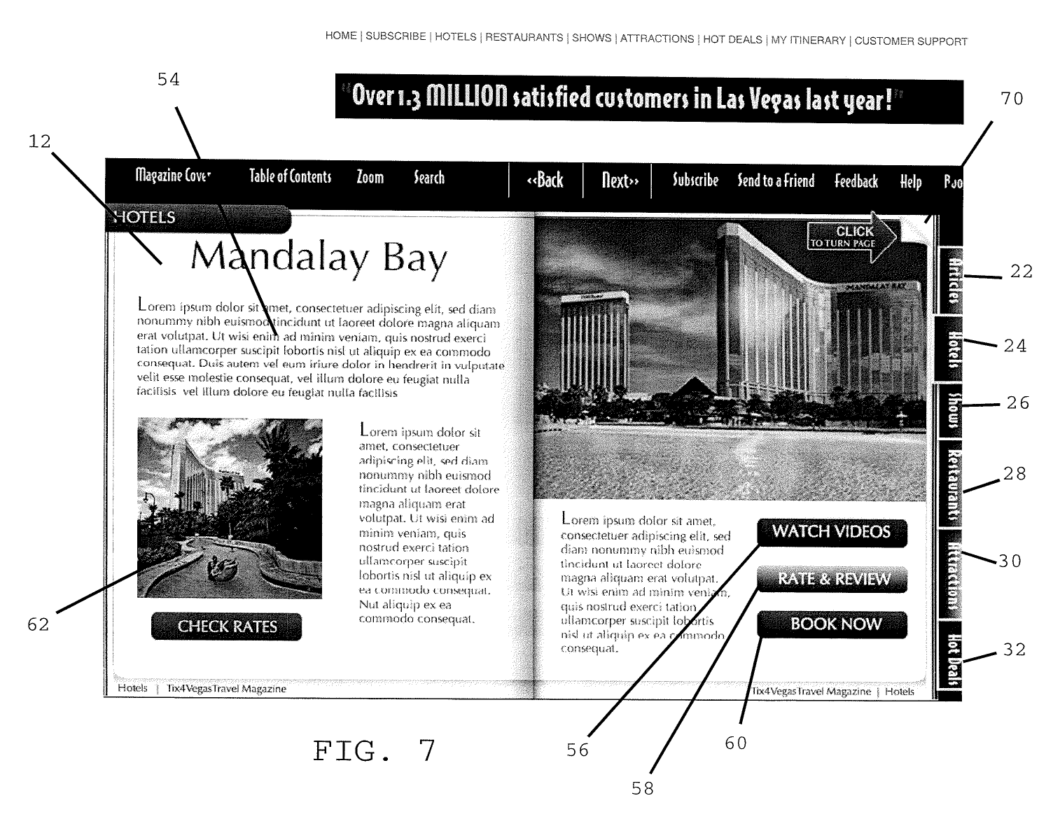

Similarly, once the Hotels tab 24 is clicked, the consumer is brought to the hotels section (see FIG. 6) and is provided with a listing of hotels. With reference to the hotels page shown in FIG. 6, after the MORE INFO button 52 relating to MANDALAY BAY® is clicked the consumer is provided with detailed information and/or inventory regarding the hotel MANDALAY BAY® (see FIG. 7). In addition to written information 54, the user is provided the opportunity to watch a promotional video of the hotel 56, book a reservation 58, or view rates and reviews 60. When these tabs are clicked and the information and/or inventory is retrieved for access by the consumer, the information and/or inventory is provided in the form of windows displayed within the context of or otherwise in conjunction with, the virtual, travel, restaurant and entertainment booking magazine 12. As such, when a consumer wishes to watch a video of the hotel, a video window 62 will open within the virtual magazine 12 (or it might open in a separate window) providing a brief promotional video for the hotel. Similarly, when the consumer wishes to book of room, a purchase window will open through which the user may book a room for the hotel. Still further, when the consumer wishes to view rates and reviews, a window is opened providing the information desired by the consumer. Similar windows are opened depending upon the links selected and the travel information being reviewed by the consumer.

Still further, when Restaurants 28, Attractions 30 and/or Hot Deals 32 tabs are clicked, the consumer is brought to the appropriate section and is provided with information, inventory and/or options similar to those listed above for the Show and Hotels section.

As those skilled in the art will certainly appreciate, the magazine look and feel of the present graphical user interface is achieved using FLASH® technology. FLASH® is a popular authoring software developed by Macromedia and currently owned by Adobe Systems, Inc. FLASH® is used to create vector graphics-based animation programs with full-screen navigation interfaces, graphic illustrations, and simple interactivity in an anti-aliased, resizable file format that is small enough to stream across a normal modem connection. The software is currently ubiquitous on the Web, both because of its speed (vector-based animations, which can adapt to different display sizes and resolutions, play as they download) and for the smooth way it renders graphics. FLASH® files, unlike animated but rasterized GIF and JPEG, are compact, efficient, and designed for optimized delivery.

However, while FLASH® does allow for the navigation within the virtual magazine as discussed above, the presentation of content via FLASH® technology does include limitations. For example, and with particular application to the present invention, technology has just recently been developed allowing FLASH® content to be accessible to search engines (that is, it may not be viewed by search engine analytics) and, therefore, the FLASH® content is noted by search engines such as GOOGLE®, YAHOO® and BING®. With this in mind, and considering the possibility the ability of search engines to note FLASH® content might still be limited, FLASH® content of the present virtual magazine is integrated with other content displays in format viewed by search engine analytics, for example, HTML (Hypertext Mark-Up Language). This is achieved by the provision of a MORE INFORMATION button on the virtual magazine display. The MORE INFORMATION button links the user to additional content relating to the particular product, for example, hotel, restaurant, show or other travel content, by opening another window offering the additional content in an HTML format that is search engine accessible.

In particular, and in accordance with a preferred embodiment of the present invention, the MORE INFORMATION button links the user to hotel, restaurant, show or other travel content in HTML format with various other links as discussed below in greater detail. Once the MORE INFORMATION button is clicked, an HTML content window is opened over the virtual magazine, and the consumer is provided with more content concerning the hotel, restaurant, show or other travel in which he or she is interested. The switch from FLASH® content to HTML content is achieved seamlessly making the switch in the content format as transparent to the user as possible using available technology.

The content that may be provided by the present system once the HTML content is accessed is not limited and may take a variety of forms. By providing the additional content relating to travel, restaurant and entertainment in HTML in accordance with the present invention, the substantive content of the virtual travel, restaurant and entertainment booking magazine 12 is viewed by GOOGLE® analytics (or other search engine analytics). Similarly, the format of the present virtual travel, restaurant and entertainment booking magazine 12 is optimized to enhance search engine recognition and tabulation.

In addition to the inventory and/or information discussed above, the present system 10 is provided with a My Itinerary 80 where the purchases, orders and/or reservations of a consumer are maintained for convenient viewing as he or she plans a vacation.

It is contemplated the present virtual travel, restaurant and entertainment booking magazine 12 will be offered as a monthly (or other periodic distribution) edition type magazine with feature articles, event schedules, etc. so the present virtual travel, restaurant and entertainment booking magazine 12 offers benefits normally associated with traditional magazines. Because the present virtual travel, restaurant and entertainment booking magazine 12 is offered on a subscription basis, people will have subscriptions and the operators will be able to gather subscriber information through the offering of a free subscription. While free subscriptions are contemplated in accordance with a preferred embodiment, it is contemplated certain circumstances might allow for the offering of paid subscriptions. The subscription information may be used by the operators and providers to optimize both content of the virtual travel, restaurant and entertainment booking magazine 12 and the goods and services offered by the providers. The provision of a periodic subscription will also maintain the interest of consumers in the virtual travel, restaurant and entertainment booking magazine 12 by providing regularly scheduled volumes delivered via email or other electronic mechanisms.

As discussed above, advertisements are also offered in conjunction with the present virtual travel, restaurant and entertainment booking magazine 12. These advertisements are of interest to the reader, benefit the provider and offer a source of revenues for the operator of the present system.

While the preferred embodiments have been shown and described, it will be understood that there is no intent to limit the invention by such disclosure, but rather, is intended to cover all modifications and alternate constructions falling within the spirit and scope of the invention.

1. A reservation, sales, ordering and information system, comprising:
a front end interface network composed of a graphical user interface operating on multiple consumer computers and a back end network composed of a network of data sources, data input mechanisms and processing mechanisms available via the graphical user interface;
the graphical user interface being composed of a virtual travel, restaurant and entertainment booking magazine replicating a travel magazine providing ready access to information.

2. The reservation, sales, ordering and information system according to claim 1, wherein the virtual travel, restaurant and entertainment booking magazine provides access to reviews and video promotional materials regarding travel, restaurant or entertainment information of interest.

3. The reservation, sales, ordering and information system according to claim 1, wherein the virtual travel, restaurant and entertainment booking magazine provides ordering, reserving, or purchasing of services or goods.

4. The reservation, sales, ordering and information system according to claim 1, wherein the back end network includes a content server linked to a plurality of providers of goods or services via a global communication network.

5. The reservation, sales, ordering and information system according to claim 4, wherein the content server stores and distributes content relating to goods or services of the plurality of providers for viewing upon the graphical user interface.

6. The reservation, sales, ordering and information system according to claim 4, wherein the content server includes a booking engine allowing for transactions relating to ordering, reserving or otherwise purchasing of goods or services of the plurality of providers.

7. The reservation, sales, ordering and information system according to claim 4, wherein each of the plurality of providers is enabled to access the content server for updating travel, restaurant or entertainment content stored upon the content server.

8. The reservation, sales, ordering and information system according to claim 7, wherein each of the plurality of providers directly connects with the content server for the purpose of updating information or inventory.

9. The reservation, sales, ordering and information system according to claim 7, wherein each of the plurality of providers forwards information or inventory to a consolidator that is directly connected with the content server.

10. The reservation, sales, ordering and information system according to claim 7, wherein each of the plurality of providers forwards information or inventory to an operator of the content server who will then update the information or inventory on the content server.

11. The reservation, sales, ordering and information system according to claim 1, wherein the graphical user interface provides links to articles, hotels, shows, restaurants, attractions and hot deals.

12. The reservation, sales, ordering and information system according to claim 11, wherein for each of the links to articles, hotels, shows, restaurants, attractions and hot deals the graphical user interface provides a link offering an option of watching a video promo, booking a reservation or viewing rates and reviews.

13. The reservation, sales, ordering and information system according to claim 12, wherein the links offering the consumer the option of watching a video promo, booking a reservation or viewing rates and reviews direct the consumer to a window displaying the content.

14. The reservation, sales, ordering and information system according to claim 11, wherein the virtual travel, restaurant and entertainment booking magazine includes a cover, a table of contents with hypertext links to the various sections of the virtual travel, restaurant and entertainment booking magazine, and descriptive material shown in an open magazine format.
